(19) United States
(12) Patent Application Publication
(10) Pub. No.: US 2008/0012238 A1
(43) Pub. Date: Jan. 17, 2008

(54) Method of retaining a dynamic seal in a bore that has a draft

(75) Inventors: John Christopher Kapcoe, Carleton, MI (US); Ron Maurice Noteboom, Lennox, MI (US)

Correspondence Address: DICKINSON WRIGHT PLLC, 38525 WOODWARD AVENUE, SUITE 2000, BLOOMFIELD HILLS, MI, 48304-2970, US

(73) Assignee: Federal-Mogul World Wide, Inc.

(21) Appl. No.: 11/348,714

(22) Filed: Feb. 7, 2006

(51) Int. Cl. F16J 15/32

(52) U.S. Cl. 277/572

(57) ABSTRACT

The invention provides a seal assembly for a shaft. The seal assembly includes a seal member operable to encircle a rotatable shaft. The seal member includes an outwardly facing annular sealing surface. The seal assembly also includes a carrier having an aperture sealingly receiving the annular sealing surface. The aperture extends along an axis between a first edge to a second edge. The aperture includes a first surface portion having a first surface finish and a second surface portion having a second surface finish rougher than the first surface finish. The second surface finish cooperates with the annular sealing surface to limit movement of the seal member along the axis.

### BACKGROUND OF THE INVENTION

1. Field of the Invention

The invention relates to seal for a rotatable shaft.

2. Related Prior Art

Pumps, motors and other rotating shaft machinery are often associated with liquids or emulsions and it is often desirable to reduce the likelihood of leakage of the liquids or emulsions from the machine. In the distant prior art, rope or cordage was stuffed around the drive shaft to create a seal. Later, mechanical seals were developed which include a member locked to the rotating shaft and rotatable within a stationary mounting flange mounted to the body of the machine. The seal can be achieved by the cooperation between a bearing face of the shaft and a bearing face of the housing of the equipment, each face mechanically loaded against the other to form a seal between the rotating member and the mounting flange. A fluid can be used to lubricate and cool the faces and avoid damage of either part. Sealing can become complicated to the extent that the shaft moves relative to the mounting flange.

### SUMMARY OF THE INVENTION

The invention provides a seal assembly for a shaft. The seal assembly includes a seal member operable to encircle a rotatable shaft. The seal member includes an outwardly facing annular sealing surface. The seal assembly also includes a carrier having an aperture sealingly receiving the annular sealing surface. The aperture extends along an axis. The aperture includes a first surface portion having a first surface finish and a second surface portion having a second surface finish rougher than the first surface finish. The second surface finish cooperates with the annular sealing surface to limit movement of the seal member along the axis.

### BRIEF DESCRIPTION OF THE DRAWINGS

Advantages of the present invention will become more readily appreciated when considered in connection with the following detailed description and appended drawings, wherein:

FIG. 1 is a front view of a seal assembly according to the exemplary embodiment of the invention;

FIG. 2 is a bottom view of the seal assembly shown in FIG. 1;

FIG. 3 is a partial cross-sectional view of the seal assembly taken along section lines 3-3 in FIG. 1; and

FIG. 4 is a perspective view of a portion of a carrier of the seal assembly.

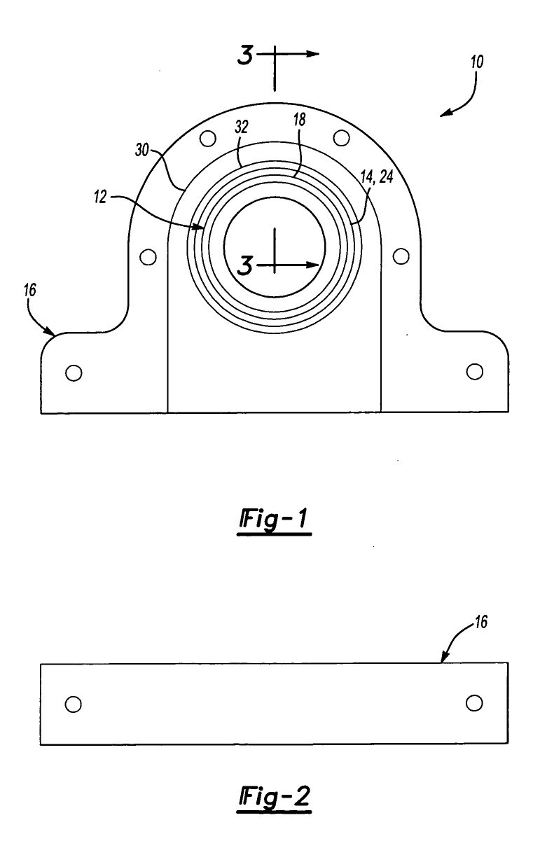

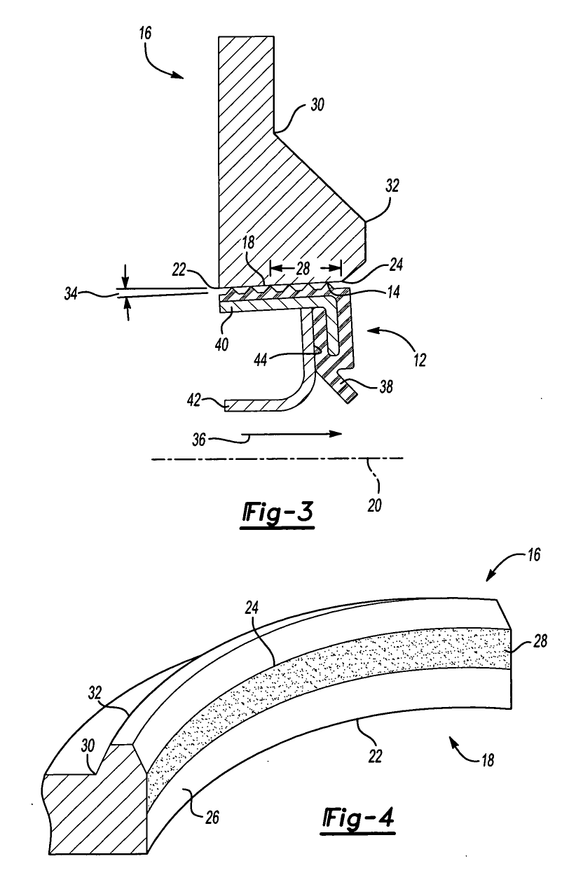

### DETAILED DESCRIPTION OF THE PREFERRED EMBODIMENT

The invention provides a seal assembly for a shaft. The seal assembly includes a seal member 12 operable to encircle a rotatable shaft. The seal member 12 includes an outwardly facing annular sealing surface 14. The seal assembly also includes a carrier 16 having an aperture 18 sealingly receiving the annular sealing surface 14. The exemplary aperture 18 extends along an axis 20 between a first edge 22 having a first diameter to second edge 24 having a second diameter greater than the first diameter. In alternative embodiments of the invention, the aperture 18 may be a constant diameter. The aperture 18 includes a first surface portion 26 having a first surface finish and a second surface portion 28 having a second surface finish rougher than the first surface finish. The second surface finish cooperates with the annular sealing surface 14 to limit movement of the seal member 12 along the axis 20.

The carrier 16 can be fixedly mounted to structure and encircle a shaft. The exemplary carrier defines several edges visible in the figures, such as edges 30 and 32. The aperture 18 of the carrier 16 defines a draft 34 whereby the diameter of the aperture 18 at the first edge 22 is greater than the diameter of the aperture 18 at the second edge 24. The seal member 12 can be inserted in the aperture 18 through the second edge 24 so that the portion of the seal member 12 finally positioned adjacent the first edge 22 is progressively compressed during insertion.

The rougher second surface portion 28 is spaced from the first edge 22 in the exemplary embodiment of the invention. Also, in the exemplary embodiment, the rougher second surface portion 28 extends along the axis 20 from the second edge 24. In alternative embodiments of the invention, the second surface portion 28 could be spaced from both edges. During operation of the exemplary embodiment, forces may tend to urge the seal member 12 out of the aperture 18 in a direction 36. The second surface portion 28 cooperates with the annular sealing surface 14 to limit movement of the seal member 12 along the axis 20. For example, friction between the second surface finish and the annular sealing surface 14 resists movement of the seal member 12 along the axis 20.

The first surface portion 26 of the exemplary embodiment of the broader invention is substantially smooth. The cooperation between smooth surface portion and the annular sealing surface 14 can provide a slightly enhanced seal between the carrier 16 and the seal member 12 relative to the seal defined between the second surface portion 28 and the annular sealing surface 14. As result, the exemplary embodiment can provide both enhanced sealing and enhanced resistance to movement of the seal member 12.

The first surface portion 26 and the second surface portion 28 are continuous in the exemplary embodiment of the invention. For example, the first surface portion 26 and the second surface portion 28 extend directly to one another from the first edge 22 and second edge 24, respectively. In alternative embodiments of the invention, the first surface portion 26 and the second surface portion 28 could be separated by a groove or notch in the aperture 18. In other alternatives, one of the first surface portion 26 and the second surface portion 28 could be defined in a groove or notch in the aperture 18 and the other of the first surface portion 26 and the second surface portion 28 could be formed in a substantially cylindrical portion of the aperture 18.

In the exemplary embodiment of the invention, the seal member 12 includes a PTFE member 38 defining the annular sealing surface 14. The PTFE member 38 may or may not contact the shaft in various embodiments of the invention. The seal member 12 also includes a steel ring 40 is fixedly engaged with the PTFE member 38. The steel ring 40 supports the annular sealing surface 14 in sealing engagement with the aperture 18. The seal member 12 also includes an elastomeric collar 42 fixedly engaged with the steel ring 40. The PTFE member is at least partially disposed between the steel ring 40 and the elastomeric collar 42. A dynamic seal 44 is defined between the elastomeric collar 42 and the PTFE member 38.

Obviously, many modifications and variations of the present invention are possible in light of the above teachings. It is, therefore, to be understood that within the scope of the appended claims, the invention may be practiced otherwise than as specifically described.

1. A seal assembly for a shaft comprising:
a seal member operable to encircle a rotatable shaft and having a PTFE member with an annular sealing surface,
a steel ring fixedly engaged with said PTFE member;
an elastomeric collar fixedly engaged with said steel ring, wherein said PTFE member is at least partially disposed between said steel ring and said elastomeric collar; and
a carrier having an aperture sealingly receiving said annular sealing surface and extending along an axis between a first edge to a second edge, wherein said aperture includes a first surface portion having a first surface finish and a second surface portion having a second surface finish rougher than said first surface finish to limit movement of said seal member along said axis.

2. The seal assembly of claim 1 wherein said rougher second surface portion is spaced from said first edge.

3. The seal assembly of claim 2 wherein said rougher second surface portion extends along said axis from said second edge.

4. The seal assembly of claim 3 wherein said first surface portion is substantially smooth.

5. The seal assembly of claim 3 wherein said first surface portion and said second surface portion are continuous.

6. The seal assembly of claim 3 wherein said first surface portion and said second surface portion extend directly to one another from said first edge and second edge, respectively.

7. (canceled)

8. The seal assembly of claim 1 wherein a dynamic seal is defined between said elastomeric collar and said PTFE member.

9. The seal assembly of claim 1 wherein said first edge is further defined as having a first diameter and said second edge is further defined as having a second diameter greater than said first diameter.

10. The seal assembly of claim 9 wherein said rougher second surface portion is spaced from said first edge.

11. The seal assembly of claim 10 wherein said rougher second surface portion extends along said axis from said second edge.

12. The seal assembly of claim 11 wherein said first surface portion and said second surface portion are continuous.

13. The seal assembly of claim 12 wherein said first surface portion and said second surface portion extend directly to one another from said first edge and second edge, respectively.

14. A seal assembly for a shaft comprising:
a seal member operable to encircle a rotatable shaft and having an outwardly facing annular sealing surface; and
a carrier having an aperture sealingly receiving said annular sealing surface and extending along an axis between a first edge to a second edge, wherein said aperture includes a first surface portion having a first surface finish and a second surface portion having a second surface finish rougher than said first surface finish to limit movement of said seal member along said axis and wherein said first edge is further defined as having a first diameter and said second edge is further defined as having a second diameter greater than said first diameter.

15. The seal assembly of claim 14 wherein said rougher second surface portion is spaced from said first edge.

16. The seal assembly of claim 15 wherein said rougher second surface portion extends along said axis from said second edge.

17. The seal assembly of claim 14 wherein said first surface portion and said second surface portion are continuous.

18. The seal assembly of claim 14 wherein said first surface portion and said second surface portion extend directly to one another from said first edge and second edge, respectively.
